(19) United States
(12) Patent Application Publication
(10) Pub. No.: US 2012/0230889 A1
(43) Pub. Date: Sep. 13, 2012

(54) MICROCHIP

(75) Inventors: Shun Momose, Kyoto (JP); Hiroki Takeuchi, Kyoto (JP); Nobuaki Jitsuhara, Kyoto (JP); Munekazu Tsujikawa, Kyoto (JP)

(73) Assignee: Rohm Co., Ltd., Kyoto (JP)

(21) Appl. No.: 13/416,545

(22) Filed: Mar. 9, 2012

(30) Foreign Application Priority Data
Mar. 10, 2011 (JP) 2011-052501

(51) Int. Cl. B01L 3/00

(52) U.S. Cl. 422/506

(57) ABSTRACT

A microchip includes a fluid circuit defined by a space formed in the microchip and migrates a liquid present in the fluid circuit to a desired position in the fluid circuit by applying a centrifugal force, the fluid circuit being made of thermoplastic resin. The thermoplastic resin is a polymer having an alkyl group of more than 3 carbon atoms as side chains.

### CROSS-REFERENCE TO RELATED APPLICATION(S)

This application is based upon and claims the benefit of priority from Japanese Patent Application No. 2011-052501, filed on Mar. 10, 2011, the entire contents of which are incorporated herein by reference.

### TECHNICAL FIELD

The present disclosure relates to a microchip useful for a μ-TAS (Micro Total Analysis System) which is suitable for biochemical examination on DNAs (Deoxyribo Nuclear Acids), proteins, cells, immunities, bloods and so on, chemical synthesis, environmental analysis, etc.

### BACKGROUND

In recent years, sensing, detection and quantization of biomaterials such as DNA, enzymes, antigens, antibodies, proteins, viruses and cells, and chemical substances in the fields of medicine, health, food, etc., increasingly become more important. Accordingly, a variety of biochips and micro chemical chips (hereinafter collectively referred to as “microchips”) which facilitate simple measurement of these biomaterials and chemical substances has been proposed.

A microchip provides many advantages. For example, a series of analytical and experimental operations, which have been carried out in laboratories, can be carried out in a square chip having a dimension of several centimeters in lengths and several millimeters to one centimeter in thickness. Thus, this may result in a tiny amount of specimens and reagents required for analysis and experiment, lower costs, a high throughput due to fast reaction, a direct acquisition of results of examination in the field where the specimens are collected, etc. Such a microchip is suitable for biochemical examination such as blood tests and so on.

Conventionally, a microchip contains a channel network (also called a fluid circuit or a micro fluid circuit) including a plurality of regions (chambers) for subjecting a liquid, such as a specimen and a reagent, present in the circuit to a specific treatment, and minute channels which properly interconnect these regions. The fluid circuit of the microchip is used for examination and/or analysis of the specimen and performs various treatments. The treatment includes measuring the specimen introduced into the fluid circuit and the reagent to be mixed with the specimen by migrating them to a measuring unit, which is a region for measurement, mixing the specimen and the reagent by migrating them to a mixing unit, which is a region for mixture, and migrating them from one region to another. A treatment performed for various kinds of liquids including a specimen, a particular ingredient in the specimen, a liquid reagent, and a mixture thereof in the microchip is hereinafter referred to as a “fluid treatment.” These fluid treatments may be performed by applying different centrifugal forces to the microchip in proper directions.

In the microchip for performing the fluid treatments by migrating the liquids in the fluid circuit to a desired position (region) in the fluid circuit using the centrifugal forces, a surface treatment using a water repellent agent such as fluorine-based resin or the like has been performed for an inner wall of the fluid circuit in order to prevent an undesigned liquid migration due to a capillary effect. Such undesigned liquid migration is likely to produce an error when measuring the specimen or the reagent and an error in a mixture ratio of the specimen and the reagent, and to deteriorate a degree of precision when an examination or an analysis are performed by the microchip.

On the other hand, the surface treatment using the water repellent agent complicates processes of manufacturing the microchip and increases manufacturing costs. In addition, a technically difficult task (or including at least a more complicated microchip manufacturing process) is required to perform the water repellency treatment for the entire inner wall of the fluid circuit. Further, if the water repellency treatment is not performed on any surface in the inner wall of the fluid circuit, the unintended liquid migration due to a surface tension sometimes has occurred. For example, when the microchip is fabricated by adhering a thermoplastic resin substrate having grooves (concave portions) formed thereon to another thermoplastic resin substrate by means of laser welding or the like, the fluid circuit is defined by the grooves and a surface of the another substrate. However, although the water repellency treatment may easily performed on a side wall and bottom of the grooves, it may not so easy to perform the water repellency treatment on only a portion of the surface of the another substrate covering the grooves. That is, it is considerably difficult to perform the water repellency treatment on all of four surfaces of the inner wall of the fluid circuit.

Therefore, there is a strong need for a microchip to meet the following requirements in addition to the water repellency of the fluid circuit.

(1) High light transmittance: A microchip for biochemical examination or the like typically includes a cuvette (also called a detecting unit) for optical measurement, as a part of the fluid circuit. The cuvette allows qualitative or quantitative analysis on a particular ingredient contained in a mixed solution obtained by mixing a specimen and a reagent. The mixed solution received in the cuvette is provided for optical measurement such as detecting the intensity of light transmitting through the cuvette from the outside of the microchip. Accordingly, since the microchip performing such optical measurement needs to obtain a high degree of precision, the microchip is required to be made of thermoplastic resin having high light transmittance.

(2) Low absorbency: The microchip for a biochemical examination or the like typically contains a reagent to be mixed with a specimen in a predetermined region (reagent retaining unit) in the fluid circuit. Since a very small amount of reagent (of a volume of 10 to 30 μL, for example) is contained in the microchip, if water in the reagent is absorbed into the thermoplastic resin of which the microchip is made, a concentration of the reagent is greatly varied to have an adverse effect on results of the examination or analysis of the microchip. Accordingly, the microchip containing the reagent is required to be made of thermoplastic resin having low absorbency.

(3) High reagent storage stability: Deterioration of the reagent has an adverse effect on results of examination or analysis. Thus, the microchip containing the reagent is required to stably store the reagent for a period of time measuring from when the microchip is manufactured by injecting the reagent into the reagent retaining unit to when the examination or analysis of the microchip is performed.

(4) High manufacturability: The microchip is required to be made of thermoplastic resin having high moldability (high degree of precision in dimension of mold transfer) from the standpoint of manufacturability (efficiency of manufacture) and degree of precision of the examination and analysis of the microchip.

### SUMMARY

The present disclosure provides some embodiments of a microchip with high light transmittance, low absorbency, high reagent storage stability and high manufacturability, which is capable of providing a fluid circuit inner wall having water repellency without performing a separate water repellency treatment to effectively prevent an unintended (undesigned) liquid migration due to a capillary effect.

The present inventors have reviewed constituent material of a microchip in various aspects and discovered that thermoplastic resin having voluminous alkyl side chain having more than 3 carbon atoms, particularly thermoplastic resin having an isobutyl group as side chains, can be used to effectively prevent liquid migration due to a capillary effect without performing a surface treatment using a separate water repellent agent.

According to one embodiment of the present disclosure, there is provided a microchip which includes a fluid circuit defined by a space formed in the microchip and migrates a liquid present in the fluid circuit to a desired position in the fluid circuit by applying a centrifugal force. The fluid circuit is made of thermoplastic resin, wherein the thermoplastic resin is a polymer having an alkyl group of more than 3 carbon atoms as side chains.

The thermoplastic resin is preferably a polymer having an isobutyl group as side chains, more preferably poly(4-methyl-1-pentene).

The microchip may include a stacked structure including a first substrate having grooves formed thereon and a second substrate and the first and second substrates may be made of the thermoplastic resin. In this case, the fluid circuit is defined by a space formed by the grooves and a surface of the second substrate opposing the first substrate.

### BRIEF DESCRIPTION OF THE DRAWINGS

FIG. 1 is a top view illustrating a microchip according to an embodiment of the present disclosure.

FIG. 2 is a graph illustrating a variation in a rate of change of absorbance shown by reagents for γ-GTP measurement when the reagents are conserved in a microchip made of PET (polyethyleneterephtalate) resin, styrene-based special material resin or polymethylpentene.

FIG. 3 is a graph illustrating a variation in a rate of change of absorbance shown by reagents for HbAlc measurement when the reagents are conserved in a microchip made of polymethylpentene, styrene-based special material resin, polystyrene resin or cycloolefin-based copolymer resin.

FIG. 4 is a graph illustrating a variation in a rate of change of absorbance shown by reagents for TG (triglyceride) measurement when the reagents are conserved in a microchip.

### DETAILED DESCRIPTION

Reference will now be made in detail to various embodiments, examples of which are illustrated in the accompanying drawings. In the following detailed description, numerous specific details are set forth in order to provide a thorough understanding of the present invention(s). However, it will be apparent to one of ordinary skill in the art that the present invention(s) may be practiced without these specific details. In other instances, well-known methods, procedures, systems, and components have not been described in detail so as not to unnecessarily obscure aspects of the various embodiments.

A microchip of the present disclosure is a chip capable of various chemical syntheses, examinations, analyses and so on using an internal fluid circuit. Further, the microchip may have a stacked structure including a first substrate having grooves (concave portions) formed thereon and a second substrate stacked on the first substrate. In this case, the fluid circuit of the microchip is defined by an internal space formed by the grooves and a surface of the second substrate opposing the first substrate. The substrates of the microchip of the present disclosure are both made of thermoplastic resin.

In addition, the microchip according to the present disclosure may have a stacked structure including a first substrate having grooves (concave portions) formed on both surfaces thereof and second and third substrates stacked on the first substrate interposed therebetween. In this case, a fluid circuit has a two-layered structure including a first fluid circuit defined by a space formed by a surface of the second substrate opposing the first substrate and grooves formed on a surface of the first substrate opposing the second substrate, and a second fluid circuit defined by a space formed by a surface of the third substrate opposing the first substrate and grooves formed on a surface of the first substrate opposing the third substrate. As used herein, the term “two-layered” means that fluid circuits are placed at two different positions with respect to the thickness direction of the microchip. Such two-layered fluid circuits may be interconnected through a through hole penetrating through the first substrate in the thickness direction.

The size of the microchip is not particularly limited. For example, the microchip may be of a square shape having dimensions of several to 10 centimeters in length and several millimeters to several centimeters in thickness.

A method of boding thermoplastic resin substrates is not particularly limited. For example, a bonding surface of at least one of the substrates to be bonded may be melted and welded (welding method), or may be bonded using an adhesive. The welding method may include a method of heating and welding a substrate, a method of welding a substrate using heat generated in light absorption with irradiation of light such as laser light (laser welding), and a method of welding a substrate using an ultrasonic wave. The laser welding is preferred.

If the microchip is composed of the first substrate having grooves formed thereon and the second substrate, the first substrate is preferably a transparent substrate. The transparent substrate typically includes a region irradiated with detection light for optical measurement (a detection light transmitting surface of a cuvette for optical measurement). The second substrate may be either a transparent substrate or an opaque substrate. In this case, the opaque substrate as the second substrate is preferred since light absorbance may increase in the laser welding method. Specifically, a black substrate, which may be obtained by adding a black pigment such as carbon black or the like to thermoplastic resin, is preferred.

If the microchip has the above-mentioned three-layered structure including the first to third substrates, an opaque substrate as the first substrate is preferred for laser welding for the increase in light absorbance in the laser welding method, and specifically, a black substrate as the first substrate is preferred. On the other hand, each of the second and third substrates is preferably a transparent substrate for the purpose of construction of a detection unit (a cuvette for optical measurement). When each of the second and third substrates is the transparent substrate, the detection unit (the cuvette for optical measurement) can be formed by a through hole formed in the first substrate and the transparent second and third substrates, and performing the optical measurement such as detecting the intensity of transmitting light (transmittance) is possible by irradiating the detection unit with light in a direction substantially perpendicular to a surface of the microchip.

A method of forming grooves (pattern grooves) constituting a fluid circuit on the surface of the first substrate is not particularly limited. Examples of a method of forming such grooves may include an injection molding method using a mold having a transferring structure, an imprinting method, etc. Among these, using the injection molding method is preferred.

The microchip of the present disclosure can perform a proper fluid treatment to move a liquid (a specimen, a specific ingredient in the specimen, a liquid reagent, a mixture thereof, etc) to a predetermined position (region) of the fluid circuit by applying a centrifugal force. To this end, the fluid circuit includes a plurality of regions which are arranged at proper positions and are appropriately interconnected via minute channels. A shape (pattern) of the grooves formed on the first substrate is determined to provide a desired proper fluid circuit structure.

The fluid circuit may include a reagent retaining unit for retaining a reagent to be mixed with (or to react with) a specimen to be examined or analyzed, a separation unit for extracting a particular ingredient from the specimen introduced into the fluid circuit, a specimen measuring unit for measuring the specimen (including the particular ingredient in the specimen, the same as above), a reagent measuring unit for measuring the reagent; a mixing unit for mixing the specimen and the reagent, and a detecting unit (a cuvette for optical measurement) for examining or analyzing a resultant mixed solution (for example, detecting or quantifying a particular ingredient in the mixed solution). A method for examining and analyzing the microchip is not particularly limited. A method for examining and analyzing the microchip may include an optical measurement method for detecting the intensity of transmitting light (transmittance) with irradiation of the detecting unit receiving the mixed solution with light, and a method for measuring an absorption spectrum for the mixed solution retained in the detecting unit. The microchip of the present disclosure may have all or some of the above-mentioned regions and may have regions other than the above-mentioned regions.

Various fluid treatments in the fluid circuit may be performed by sequentially applying centrifugal forces to the microchip in proper directions. Such fluid treatments includes extracting the particular ingredient from the specimen in order to separate unnecessary ingredients from the specimen, measuring the specimen and/or the reagent, mixing the specimen and the reagent, and introducing the resultant mixed solution into the detecting unit. The centrifugal forces may be applied to the microchip using a centrifugal device capable of applying a centrifugal force on which the microchip is placed. The centrifugal device may include a rotatable rotor (or a rotator) and a rotatable stage disposed on the rotor. When the stage with the microchip located thereon is rotated to be set at an angle with respect to the rotor, the centrifugal force may be applied to the microchip in a desired direction.

In some embodiments, the microchip of the present disclosure is made of thermoplastic resin which is a polymer having an alkyl group of more than 3 carbon atoms as side chains. Specifically, if the microchip has a stacked structure including the first and second substrates or the first to third substrates, all of these substrates of the microchip are made of the polymeric thermoplastic resin. The use of such thermoplastic resin can improve water repellency of an inner wall of the fluid circuit without carrying out any surface treatment using a separate water repellent agent. Further, the use of the thermoplastic resin effectively prevents any unintended (undesigned) liquid migration due to a capillary effect. This may improve a precision when examining and analyzing the microchip. Since the microchip of the present disclosure requires no surface treatment, it is cost effective when manufacturing the microchip.

In addition, since the microchip made of thermoplastic resin according to the present disclosure has high water repellency, the entire inner wall (including four sides) of the fluid circuit has high water repellency as well, as opposed to when a water repellent agent is used. This effectively prevents any undesired liquid migration due to a capillary effect.

The water repellency of thermoplastic resin tends to increase with an increase in a volume size of side chains. Accordingly, the side chain of the thermoplastic resin of the microchip according to the present disclosure is preferably a branched alkyl group. Examples of the side chain may include an isopropyl group, an isobutyl group, an isopentyl group, and a neopentyl group. Among these, using the isobutyl group, the isopentyl group and the neopentyl group is preferred in considering the volume of the side chain. Further, using poly(4-methyl-1-pentene) as the side chains is preferred for the thermoplastic resin having the isobutyl group.

The thermoplastic resin having the alkyl group of more than 3 carbon atoms as the side chain, particularly, the thermoplastic resin having the isobutyl group such as poly(4-methyl-1-pentene) as the side chains, are excellent in terms of light transmittance, absorbency, reagent storage stability and manufacturability. Thus, the microchip according to the present disclosure is very suitable as a reagent-contained microchip which performs optical measurement.

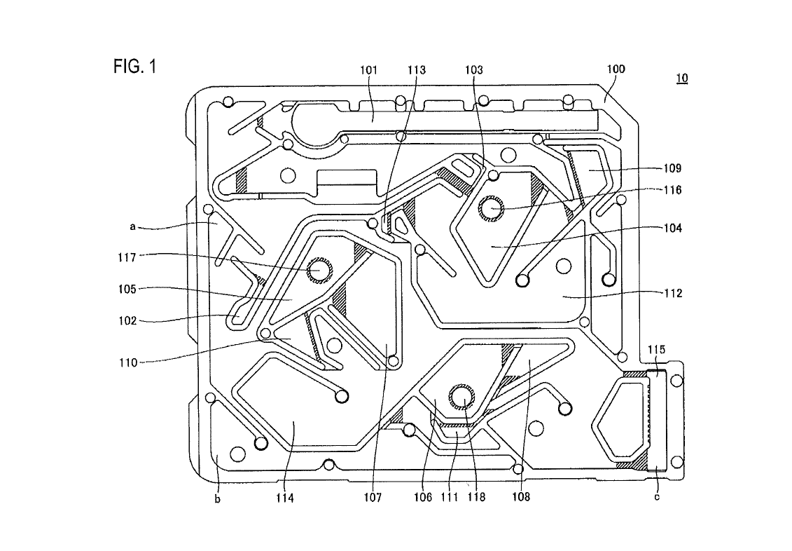

Next, a configuration of a fluid circuit in a microchip of the present disclosure will be described according to the present disclosure. FIG. 1 is a top view illustrating a microchip 10 including a first substrate 100 having grooves formed thereon and a second substrate stacked on and bonded to the first substrate 100. In the microchip shown in FIG. 1, the first substrate 100 is bonded to the second substrate in such a manner that a surface on which the grooves are formed faces the second substrate. The grooves are formed on a surface opposite to the surface of the first substrate 100, and a pattern of the grooves is indicated by a solid line. In FIG. 1, the second substrate in the microchip 10 is identical to the first substrate 100 or has the same shape as the first substrate 100. The first substrate 100 is a transparent substrate and the second substrate is a black substrate, and both the first substrate 100 and the second substrate are made of, for example, poly(4-methyl-1-pentene). Portions indicated by oblique lines in FIG. 1 means that the portions have a tapered shape. That is, the bottom of grooves in one portion is inclined with respect to the bottom of grooves in an adjacent portion.

Further, the fluid circuit of the microchip 10 mainly includes a sample tube placement unit 101, a separation unit 102, a blood cell measuring unit 103, three reagent retaining units 104, 105 and 106, reagent receiving units 107 and 108, three reagent measuring units 109, 110 and 111, a first mixing unit 112, a mixed solution measuring unit 113, a second mixing unit 114, and a detecting unit 115. The sample tube placement unit 101 places a sample tube, such as a capillary or the like, containing whole blood collected from a subject. The separation unit 102 separates the whole blood drawn from the sample tube into a blood cell ingredient and a plasma ingredient, and the blood cell measuring unit 103 for measuring the separated blood cell ingredient. Three reagent retaining units 104, 105 and 106 retains liquid reagents, and reagent receiving units 107 and 108 which are disposed adjacent to the reagent retaining units 105 and 106, respectively, temporarily receives the liquid reagents. Further, three reagent measuring units 109, 110 and 111 measures the liquid reagents. The first mixing unit 112 mixes the blood cell ingredient and the liquid reagents, the mixed solution measuring unit 113 measures a mixed solution of the blood cell ingredient and the liquid reagents, and the second mixing unit 114 mixes the mixed solution of the blood cell ingredient and the liquid reagents and other liquid reagents. In addition, the detecting unit 115 examines and analyzes a resultant mixed solution. The three reagent retaining units 104, 105 and 106 have the respective reagent inlets 116, 117 and 118 for injecting the liquid reagents into the reagent retaining units. The reagent inlets 116, 117 and 118 are through-holes which penetrate through the first substrate 100 in its thickness direction. In the following description, the liquid reagents injected into and retained in the reagent retaining units 104, 105 and 106 through the reagent inlets 116, 117 and 118 are called “liquid reagents R0, R1 and R2,” respectively.

As described above, the fluid circuit of the microchip 10 according to the present disclosure is adapted to sequentially mix the liquid reagents R0, R1 and R2 with the blood cell ingredient separated from the whole blood and to perform examination and analysis, including optical measurement and so on, for an obtained mixed solution.

A method of operating the microchip 10 shown in FIG. 1 will be described below. The following operation is merely illustrated by way of example without being limited thereto. First, a sample tube which contains a whole blood sample is inserted in the sample tube placement unit 101. Next, the whole blood sample is extracted from the sample tube by applying a centrifugal force to the microchip 10 in a direction toward the left side in FIG. 1 (hereinafter simply referred to as “left direction,” the same as above for other directions) and the plasma ingredient is separated from the blood cell ingredient by introducing the whole blood sample into the separation unit 102 and performing centrifugation for the whole blood sample using a centrifugal force in a downward direction. Next, an upper plasma ingredient is removed by a centrifugal force in the left direction. The removed plasma ingredient is received in a region a. Subsequently, a centrifugal force is applied in the downward direction to adjust a liquid level of the blood cell ingredient within the separation unit 101 while moving the removed plasma ingredient to a region b. Next, a centrifugal force is applied in a right direction to introduce the liquid reagent R0 from the reagent retaining unit 104 into the reagent measuring unit 109 for measurement. This centrifugal force causes the liquid reagent R1 in the reagent retaining unit 105 and the liquid reagent R2 in the reagent retaining unit 106 to be moved to the reagent receiving units 107 and 108, respectively. In addition, this centrifugal force causes the blood cell ingredient in the separation unit 102 to be introduced into the blood cell measuring unit 103 for measurement.

Next, a centrifugal is applied in the downward direction to obtain a mixed solution by mixing the measured blood cell ingredient and the liquid reagent R0 in the first mixing unit 112. This centrifugal force causes the liquid reagent R2 in the reagent receiving unit 108 to be measured by the reagent measuring unit 111. Subsequently, centrifugal forces are sequentially applied in the right, downward, left and downward directions to blend the mixed solution well. In addition, a centrifugal force is applied in the left direction to allow the reagent measuring unit 110 to measure the liquid reagent R1 in the reagent receiving unit 107. Next, a centrifugal force is applied in the downward direction to move the measured liquid reagent R1 to the second mixing unit 114.

Next, centrifugal forces are sequentially applied in a top left direction and the left direction to introduce an upper clear portion of the mixed solution in the first mixing unit 112 into the mixed solution measuring unit 113 for measurement. Next, a centrifugal force is applied in the downward direction to allow the second mixing unit 114 to mix the measured solution and the liquid reagent R1. Subsequently, centrifugal forces are sequentially applied in the left and downward directions to blend the mixed solution well. Under the application of the centrifugal force in the downward direction, the measured liquid reagent R2 is located in a region c. Next, a centrifugal force is applied in the right direction to allow the detecting unit 115 to mix the mixed solution and the liquid reagent R2 and a centrifugal force is applied in the downward direction to blend the mixed solution well. Finally, a centrifugal force is applied in the right direction to cause the mixed solution to be received in the detecting unit 115 which is then irradiated with light for measurement of optical properties such as the intensity of transmitting light.

The present disclosures will be described in detail by way of examples but it is understood that the present disclosure is not limited to present descriptions.

As described above, the microchip 10, particularly a reagent-contained microchip 10 for optical measurement, requires high water repellency of a fluid circuit inner wall, high light transmittance, low absorbency, high reagent storage stability and high manufacturability. For the purpose of discovery of microchip constituent materials to meet all of the required properties, the following 15 kinds of thermoplastic resins were chosen as candidates for evaluation and verification. Results of the verification are shown in Table 1.

(1) Fluorine resin: “Teflon® PFA” available from Mitsui & Du Pont Fluorochemicals Co., Ltd.

(2) Polymethylpentene: “TPX” available from Mitsui Chemicals, Incorporated.

(3) Styrene-based special material resin: “AshaFlex” available from Ashahi Kasei Chemicals, Incorporated

(4) Polypropylene resin: “PrimePolyPro” available from Prime Polymer, Incorporated

(5) MS resin (methylmethacrylate-styrene copolymer resin): “DenkaTXpolymer” available from Denki Kagaku Kogyo K.K.

(6) Polycarbonate resin: “Fanlight” available from Teijin Kasei K.K.

(7) Methacrylic resin: “Delpet” available from Mitsubishi Rayon Co., Ltd.

(8) Polystyrene resin: “Dicstyrene” available from DIC Co., Ltd.

(9) Polystyrene resin: “G100C” available from Toyo Stylene Co., Ltd.

(10) ABS resin (acrylonitrile-butadiene-styrene copolymer resin): “DenkaABS” available from Denki Kagaku Kogyo K.K.

(11) AS resin (acrylonitrile-styrene copolylner resin): “Stairak•AS” available from Ashahi Kasei Chemicals, Incorporated

(12) PET resin (polyethyleneterephtalate resin): “Daiyanight” available from Mitsubishi Rayon Co., Ltd.

(13) Cycloolefine resin: “Zeonor” available from Japanese Zeon K.K.

(14) Cycloolefine-based copolymer resin: “TOPAS” available from PolyPlastics Co., Ltd.

(15) Ionomer resin: “HighMilan” available from Mitsui & Du Pont Polychemicals Co., Ltd.

(Verification and Results)

### [a] Water Repellency of Fluid Circuit Inner Wall

An automated contact angle measuring device was used to measure contact angles of different kinds of thermoplastic resins for a surfactant aqueous solution. Results of the measurement are shown in Table 1. Among the above 15 kinds of thermoplastic resins, only (1) fluorine resin and (2) polymethylpentene resin showed a sufficiently high contact angle. On the other hand, other thermoplastic resins do not have a sufficiently high contact angle. Thus, other thermoplastic resins require a separate water repellency treatment for the fluid circuit inner wall in order to use of these thermoplastic resins as constituent materials of the microchip. As a result of the measurement, a contact angle of polyethylene resin for the surfactant aqueous solution was 21.4 degrees. Contact angles of (4) polypropylene resin and (2) polymethylpentene resin were 31.3 degrees and 51.3 degrees, respectively. It can be seen from this result that water repellency increases with an increase in a volume size of alkyl side chains. Using the surfactant aqueous solution is desirable because the reagent used for examination contains a surfactant in many cases. Further, the surfactant aqueous solution is very suitable for evaluating of the water repellency of the fluid circuit inner wall since it has very a high wettability and a small contact angle, and is likely to generate an unintended liquid migration due to a capillary effect.

### [b] Light Transmittance

An ultraviolet/visible spectrophotometer (UV-Vis) was used to evaluate light transmittance of different kinds of thermoplastic resins. Results of the evaluation are shown in Table 1. Although many thermoplastic resins showed high light transmittance, (1) fluorine resin and (2) polypropylene resin showed insufficient light transmittance in order to use as a constituent material of the microchip performing the optical measurement.

### [c] Absorbency

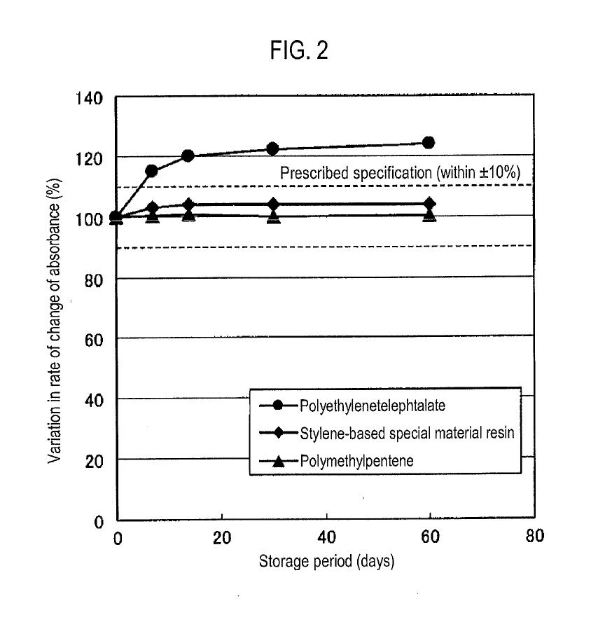

(12) A PET resin was used to prepare the first substrate and the second substrate having the same external shape as the first substrate, both of which have the structure shown in FIG. 1. A microchip was then prepared by bonding these substrates together using the laser welding method. In this case, the first substrate was transparent and the second substrate was a black substrate obtained by mixing carbon black with the resin. Subsequently, a reagent for γ-GTP measurement was injected by an amount of 20 μL from the reagent inlet 116 into the reagent retaining unit 104, and then the reagent inlet 116 was sealed with a sealant. The resultant reagent-contained microchip was stored for 60 days at a room temperature and a variation in a rate of change of absorbance (meaning a measurement of γ-GTP concentration, the same as above) of the reagent for the storage period of 60 days was verified. A result of the verification is shown in FIG. 2. FIG. 2 shows also a result of evaluation for a microchip prepared using (2) polymethylpentene resin or (3) styrene-based special material resin. As shown in FIG. 2, (12) PET resin shows a great variation in the rate of change of absorbance and cannot meet a prescribed specification. The prescribed specification states that a rate of change of absorbance for a cold storage period of 180 to 360 days is within a range of ±10% of the initial absorbance. The current test is an acceleration test and a storage condition of “60 days at room temperature” in the current test corresponds to a cold storage period of 300 days or so. The result shows that this variation in the rate of change of absorbance is attributed to a change in reagent concentration due to absorption of water in the reagent into the PET resin.

On the other hand, (2) polymethylpentene resin and (3) styrene-based special material resin sufficiently meets the prescribed specification.

Additionally, an electronic scale was used to measure absorptance of the above-mentioned 15 kinds of thermoplastic resins, including (12) PET resin. A result of the measurement is shown in Table 1. As used herein, the term “absorptance” refers to a ratio of an increase in weight to the original weight when a resin is immersed in distilled water for 24 hours at water temperature of 25 degrees C. As the absorptance of (12) PET resin was 0.2%, (6) polycarbonate resin, (7) methacrylic resin, (10) ABS resin and (11) AS resin, all of which have the absorptance of more than 0.2%, in addition to (12) PET resin, are inappropriate as a constituent material of the reagent-contained microchip,

### [d] Reagent Storage Stability

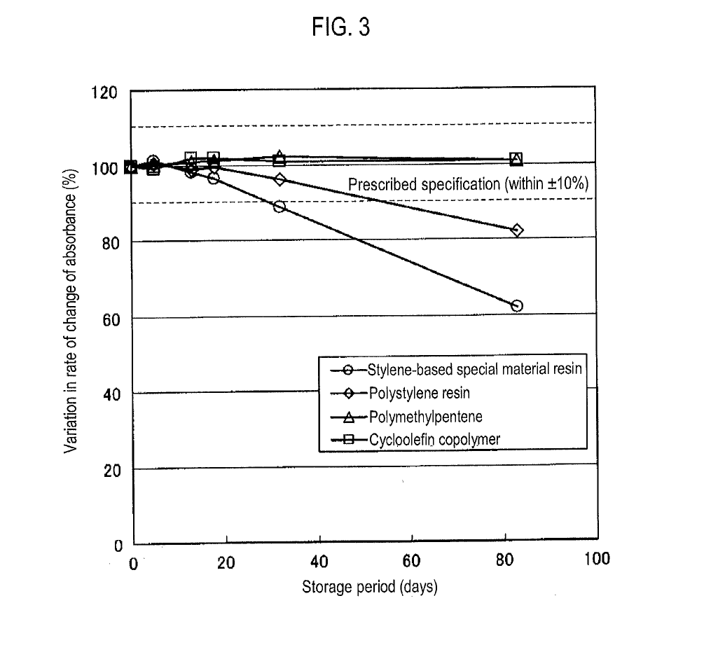

(2) Polymethylpentene, (3) styrene-based special material resin, (8) polystyrene resin or (14) cycloolefine-based copolymer resin was used to prepare the first substrate and the second substrate having the same external shape as the first substrate, both of which have the structure shown in FIG. 1. A microchip was then prepared by bonding these substrates together using the laser welding method. In this case, the first substrate is transparent and the second substrate is a black substrate obtained by mixing carbon black with the resin. Subsequently, a reagent for hemoglobin Alc (HbAlc) measurement was injected by an amount of 20 μL from the reagent inlet 116 into the reagent retaining unit 104 and then the reagent inlet 116 was sealed with a sealant. The resultant reagent-contained microchip was stored for 80 days at the room temperature and a variation in a rate of change of absorbance of the reagent for the storage period of 80 days was verified. A result of the verification is shown in FIG. 3. As shown in FIG. 3, (3) styrene-based special material resin and (8) polystyrene resin show a great variation in the rate of change of absorbance due to deterioration of the reagent and cannot meet a prescribed specification. The prescribed specification states that a rate of change of absorbance for a cold storage period of 180 to 360 days is within a range of ±10% of the initial absorbance. This test is an acceleration test, “60 days at room temperature” corresponds to a cold storage period of 300 days or so, and a storage condition of “80 days at room temperature” in this test corresponds to a cold storage period of 400 days or so. On the other hand, (2) polymethylpentene resin and (14) cycloolefin-based copolymer resin meets the prescribed specification sufficiently.

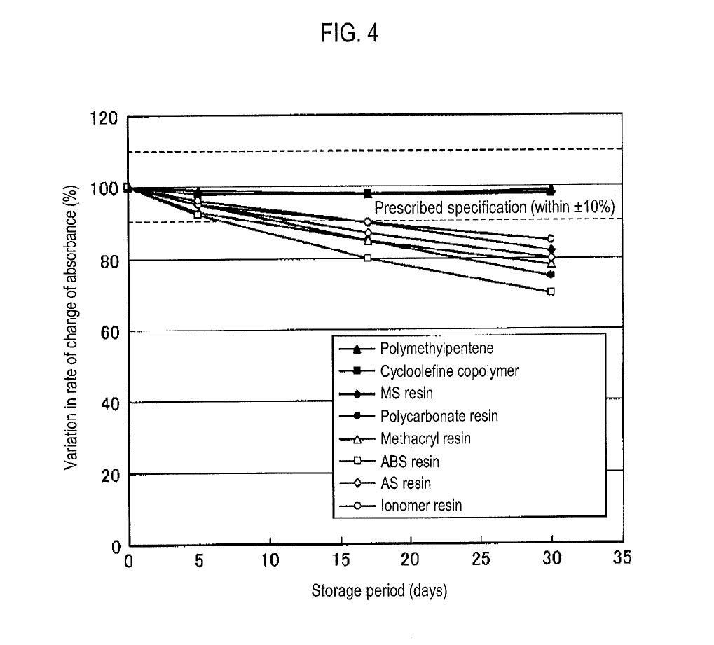

In addition, a reagent storage stability test was carried out under the same conditions except that the reagent retained in the reagent retaining unit 104 was changed to a reagent for triglyceride (TG) measurement. A result of the test is shown in FIG. 4. The number of thermoplastic resins is 8 as shown in FIG. 4 and a storage period at the room temperature was set to 30 days. As shown in FIG. 4, it is apparent that (5) MS resin, (6) polycarbonate resin, (7) methacrylic resin, (10) ABS resin, (11) MS resin and (15) ionomer resin show a great variation in the rate of change of absorbance due to deterioration of the reagent and cannot meet a prescribed specification. The prescribed specification states that a rate of change of absorbance for a cold storage period of 180 to 360 days (is within a range of ±10% of the initial absorbance. This test is an acceleration test and a storage condition of “30 days at room temperature” in this test corresponds to a cold storage period of 150 days or so. On the other hand, (2) polymethylpentene resin and (14) cycloolefin-based copolymer resin meets the prescribed specification sufficiently. In addition, (13) cycloolefin resin also has a high reagent storage stability for the HbAlc measurement reagent and the TG measurement reagent.

### [e] Manufacturability

The moldability of different kinds of thermoplastic resins was evaluated by measuring a mold shrinkage. A result of the evaluation is shown in Table 1. In Table 1, (1) fluorine resin has slightly poor moldability (mold shrinkage of 2 to 5%) and other thermoplastic resins have good moldability (mold shrinkage of less than 1.5%).

The above results of verification are listed in Table 1. Table 1 shows also results of evaluation for satisfaction of the requirements. Meanings of numerical values in columns “Evaluation” of the requirements are as follows.

1: Suitable to a constituent material of the reagent-contained microchip performing optical measurement.

2: Usable as a constituent material of the reagent-contained microchip performing optical measurement, but with low performance.

3: Unusable as a constituent material of the reagent-contained microchip performing optical measurement.

4: Usable as a constituent material of the reagent-contained microchip performing optical measurement, but requiring at least a water repellency treatment for the fluid circuit inner wall.

TABLE 1

| | | Water repellency | | | | Reagent | | |
|---|---|---|---|---|---|---|---|---|
| | | Contact | | Light | Absorbency | storage | | |
| | | angle | | transmittance | Absorptance | stability | Manufacturability | |
| Thermoplastic resin | | (degrees) | Evaluation | Evaluation | (%) | Evaluation | Evaluation | Evaluation |
| (1) | Fluorine resin | 65.0 | 1 | 3 | <0.01 | 1 | 1 | 2 |
| (2) | Polymethylpentene | 51.3 | 1 | 1 | <0.01 | 1 | 1 | 1 |
| (3) | Styrene-based special | 35.2 | 4 | 1 | <0.1 | 2 | 3 | 1 |
| | material resin | | | | | | | |
| (4) | Polypropylene resin | 31.3 | 4 | 3 | <0.01 | 2 | 3 | 1 |
| (5) | MS resin | 26.3 | 4 | 1 | 0.12 | 2 | 2 | 1 |
| (6) | Polycarbonate resin | 25.3 | 4 | 1 | 0.2 | 3 | 2 | 1 |
| (7) | Methacrylic resin | 23.8 | 4 | 1 | 0.3 | 3 | 2 | 1 |
| (8) | Polystyrene resin | 21.8 | 4 | 1 | <0.1 | 2 | 3 | 1 |
| (9) | Polystyrene resin | 20.3 | 4 | 1 | <0.1 | 2 | 3 | 1 |
| (10) | ABS resin | 19.1 | 4 | 1 | 0.2 | 3 | 2 | 1 |
| (11) | AS resin | 19.0 | 4 | 1 | 0.3 | 3 | 2 | 1 |
| (12) | PET resin | 17.5 | 4 | 1 | 0.2 | 3 | 1 | 1 |
| (13) | Cycloolefin resin | 15.3 | 4 | 1 | <0.01 | 1 | 1 | 1 |
| (14) | Cycloolefin-based | 14.2 | 4 | 1 | <0.01 | 1 | 1 | 1 |
| | copolymer resin | | | | | | | |
| (15) | Ionomer resin | 13.2 | 4 | 1 | 0.1 | 2 | 2 | 1 |

As shown in Table 1, among the verified 15 kinds of thermoplastic resins, only (2) polymethylpentene resin meets all of the requirements.

According to some embodiments of the present disclosure, 3 kinds of microchips having the following features were prepared by bonding the first substrate and the second substrate having the same external shape as the first substrate, both of which have the structure shown in FIG. 1, together using the laser welding method. In this case, the first substrate is transparent and the second substrate is a black substrate obtained by mixing carbon black with the resin.

(1) Microchip A: a microchip having the first and second substrates made of polymethylpentene resin (no surface treatment for a fluid circuit inner wall)

(2) Microchip B: a microchip having the first and second substrates made of polystyrene resin (no surface treatment for a fluid circuit inner wall)

(3) Microchip C: a microchip having the first and second substrates made of polystyrene resin (side walls and bottom of grooves of the first substrate, that is, three surface of the fluid circuit inner wall, are subjected to a surface treatment using a polytetrafluoroethylene water repellent agent)

A surfactant aqueous solution of 20 μL colored in red was introduced into the fluid circuit, centrifugal forces were applied to the microchips in various directions, and it was checked by naked eyes whether or not an unintended liquid migration occurred in directions different from the centrifugal directions. In the microchip A, the whole surfactant aqueous solution could be migrated to desired regions by the application of centrifugal forces in any directions and the unintended liquid migration due to a capillary effect did not happen even when the centrifugal forces are stopped. In contrast, in the microchip B, the unintended liquid migration due to a capillary effect happened in many cases. In the microchip C, the unintended liquid migration due to a capillary effect happened in some cases.

According to the present disclosure in some embodiments, it is possible to provide a microchip including a fluid circuit inner wall having a high water repellency without performing a separate water repellency treatment. The microchip of the present disclosure can effectively prevent an unintended (undesigned) liquid migration due to a capillary effect. Such prevention improves a degree of precision when examining and analyzing the microchip. In addition, the microchip of the present disclosure has high light transmittance, low absorbency, high reagent storage stability and high manufacturability.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures.

What is claimed is:

1. A microchip comprising:
a fluid circuit defined by a space formed in the microchip, and configured to migrate a liquid present in the fluid circuit to a desired position in the fluid circuit by applying a centrifugal force, the fluid circuit being made of thermoplastic resin,
wherein the thermoplastic resin is a polymer having an alkyl group of more than 3 carbon atoms as side chains.

2. The microchip of claim 1, wherein the thermoplastic resin is a polymer having an isobutyl group as side chains.

3. The microchip of claim 1, wherein the thermoplastic resin is poly(4-methyl-1-pentene).

4. The microchip of claim 1, further comprising:
a first substrate having grooves formed thereon; and
a second substrate opposing from the first substrate to form a stacked structure,
wherein the fluid circuit is defined by a space formed by the grooves of the first substrate and a surface of the second substrate opposing the first substrate, and
wherein the first and second substrates are made of the thermoplastic resin.

5. The microchip of claim 2, further comprising:
a first substrate having grooves formed thereon; and
a second substrate opposing from the first substrate to form a stacked structure,
wherein the fluid circuit is defined by a space formed by the grooves of the first substrate and a surface of the second substrate opposing the first substrate, and
wherein the first and second substrates are made of the thermoplastic resin.

6. The microchip of claim 3, further comprising:
a first substrate having grooves formed thereon; and
a second substrate opposing from the first substrate to form a stacked structure,
wherein the fluid circuit is defined by a space formed by the grooves of the first substrate and a surface of the second substrate opposing the first substrate, and
wherein the first and second substrates are made of the thermoplastic resin.
